(19) United States
(12) Patent Application Publication
(10) Pub. No.: US 2017/0320129 A1
(43) Pub. Date: Nov. 9, 2017

(54) METHOD FOR PRODUCING A COOLING CHANNEL PISTON AND COOLING CHANNEL PISTON PRODUCED BY SUCH A METHOD

(71) Applicant: Mahle International GmbH, Stuttgart (DE)

(72) Inventor: Ulrich Bischofberger, Esslingen (DE)

(21) Appl. No.: 15/528,278

(22) PCT Filed: Nov. 20, 2015
(86) PCT No.: PCT/EP2015/077280

§ 371 Date: May 19, 2017

(30) Foreign Application Priority Data
Nov. 20, 2014 (DE) 10 2014 017 091.8

(51) Int. Cl. B22C 9/10; B22D 21/00; B22D 15/02; F02F 3/16; F02F 3/28

(52) U.S. Cl. CPC B22C 9/105; F02F 3/16; F02F 3/28; B22D 15/02; B22D 21/007; F02F 2200/08

(57) ABSTRACT

A method for producing a cooling channel piston may include producing a salt core blank by pressing and sintering a pure salt material having a surface roughness R_{z} of at most 60 μm. The method may also include one of immersing the salt core blank into a saturated solution of the salt material, or spraying the salt core blank with a saturated solution of the salt material. The method may also include drying the salt core blank to form a salt core having a surface roughness R_{z} of at least 200 μm. The method may further include placing the salt core in a casting mold, and casting the cooling channel piston from a metallic casting material.

### CROSS-REFERENCE TO RELATED APPLICATIONS

This application claims priority to International Patent Application No. PCT/EP2015/077280, filed on Nov. 20, 2015, and German Patent Application No. DE 10 2014 017 091.8, filed on Nov. 20, 2014, the contents of both of which are incorporated hereby incorporated by reference in their entirety.

### TECHNICAL FIELD

The present invention relates to a method for producing a cooling channel piston and also to a cooling channel piston produced by such a method.

### BACKGROUND

Salt cores are used in particular for producing cast pistons with closed cooling channels. After the piston has been cast, the salt core is removed in a conventional way from the piston, by being dissolved with water. Salt cores of this kind are generally produced on the basis of sodium chloride. For this purpose, cold pressing of the material is employed in order to generate a green compact, which has a form similar to that of the cooling channel to be produced, and this compact is sintered at approximately 800° C., just below the melting point of the material. The resulting sintered component may be brought where appropriate by machine finishing into the ultimate form corresponding to the cooling channel to be produced.

The resulting salt core generally has a surface roughness R_{z} of 30 μm to 60 μm. In a modern cooling channel piston, the high thermal load in engine operation means that effective heat transfer between the piston crown and the cooling oil circulating in the cooling channel is essential.

WO 2010/133596 A2 discloses a method for producing a salt core having a particularly smooth surface. The intention here is to prevent the casting material penetrating the surface of the salt core or reacting with the salt core during the casting of a component.

### SUMMARY

The object of the present invention is to provide a method for producing a piston, and also a piston, which ensures particularly effective heat transfer between the piston material and the cooling oil circulating in the cooling channel.

A first solution lies in a method having the following features: a) producing a salt core blank by pressing and sintering a pure salt material having a surface roughness R_{z} of at most 60 μm; b) immersing the salt core blank into a saturated solution of the salt material, or spraying the salt core blank with a saturated solution of the salt material; c) drying the salt core blank to form a salt core having a surface roughness R_{z} of at least 200 μm; d) placing the salt core in a casting mold and casting a cooling channel piston from a metallic casting material.

A second solution lies in a method having the following features: e) producing a salt core blank by pressing and sintering a pure salt material having a surface roughness R_{z} of at most 60 μm; f) immersing the salt core blank into a solvent or a solution of the salt material, or spraying the salt core blank with a solvent or a solution of the salt material; g) sprinkling the salt core blank with a salt material having a defined grain size distribution and/or a defined grain diameter distribution; h) drying the salt core blank to form a salt core having a surface roughness R_{z} of at least 200 μm; i) placing the salt core in a casting mold and casting a cooling channel piston from a metallic casting material.

A further subject of the present invention is a piston producible by a method of this kind.

A feature of the methods of the invention is that it is possible to achieve a defined salt-core surface roughness which is greater than for salt cores which are produced in the customary sintering process.

According to one exemplary method, the objective of the invention is achieved by crystallizing the salt material from the saturated salt material solution in step c), the crystals settling on the sintered surface of the salt core blank and adhering firmly into the partially dissolved surface of the salt core blank. The salt crystals applied to the surface of the salt core blank by the method, furthermore, act as crystallization nuclei during the subsequent drying of the salt core blank, and so the salt crystals which precipitate from the saturated aqueous solution crystallize particularly effectively on the salt grains, resulting in particularly great surface roughness.

According to another exemplary method, the objective of the invention is achieved by partially dissolving the surface of the blank by means of a suitable solvent and/or a solution of the salt material, and subsequently sprinkling the surface, while it is still wet, with additional crystals of the salt material, having a defined grain size distribution and/or grain diameter distribution. These crystals are lodged in the partially dissolved surface of the salt core blank, and adhere firmly.

The result is a defined surface roughness of the cooling channel surface that is greater than in the prior art. Consequently, the cooling channel surface area itself is increased, and so the transfer of heat between the piston material and the oil circulating in the cooling channel in engine operation is substantially improved.

The method of the invention is easy to implement technically and can be integrated readily into existing production lines. The method of the invention has the further advantage that no extraneous substances or additives are required. Such substances or additives may considerably hamper the dissolution of the salt core after the piston has been cast. Furthermore, they can lead to release of gas during the casting of the piston. By avoiding extraneous substances or additives, damage to the cooling channel surface (as a result of hydrogen porosity, for example) is prevented. In particular there is no need to use any adhesives, which can cause gas emergence and hence blistering in the cast component.

Advantageous developments are evident from the dependent claims.

Usefully, in step a) and/or in step e), an established salt material in the form of sodium chloride is used.

In step a) and/or in step e), the salt core blank may be subjected to mechanical finishing, in order to generate an extremely precise contour of the cooling channel to be produced.

All solvents suitable for salt materials can be used, especially water and polar organic solvents; water is preferred. Also highly suitable are methanol, ethanol, isopropanol, diethyl ether, and acetone. If a polar organic solvent is used, it may be admixed with at least one crown ether, in order to improve the solubility of the salt material. Particularly suitable for the complexing of sodium ions are the cyclic openings of [15]-crown-5. Potassium ions are complexed preferentially, for example, by [18]-crown-6.

In step c) and/or step h), the salt core blank ought preferably to be dried in agitated air and at a temperature of at most 200° C. until moisture no longer emerges. With preference the salt core blank is dried particularly gently at a temperature of at most 100° C.; more preferably the drying takes place at room temperature.

In step c) and/or step h), a salt core having a surface roughness of up to 1 mm can be obtained, depending on the eventual size of the salt crystals crystallized according to the method of claim 1, or depending, respectively, on the size of the salt crystals used additionally in accordance with step g) for sprinkling on the salt core blank.

Usefully, after step a) and before step b), the salt core blank is heated to a temperature of 80° C. to 100° C., in order to obtain particularly effective wetting by the aqueous saturated salt material solution in accordance with the method of claim 1.

Furthermore, before being placed in the casting mold in accordance with step d) and/or step i), the salt core obtained in accordance with the invention may be heated to a temperature of 300° C. to 500° C., in order to prevent an excessive temperature difference from the casting material used.

The method of the invention is particularly suitable for producing cooling channel pistons from a material based on aluminum, more particularly an aluminum-silicon casting alloy.

Exemplary embodiments of the present invention are described in more detail below, with reference to the appended drawings.

### BRIEF DESCRIPTION OF THE DRAWINGS

In the drawings, in a schematic representation which is not true to scale:

FIG. 1 shows an exemplary embodiment of an inventive cooling channel piston in section;

FIG. 2 shows an exemplary embodiment of a salt core used for producing a cooling channel piston as per FIG. 1, in section.

### DETAILED DESCRIPTION

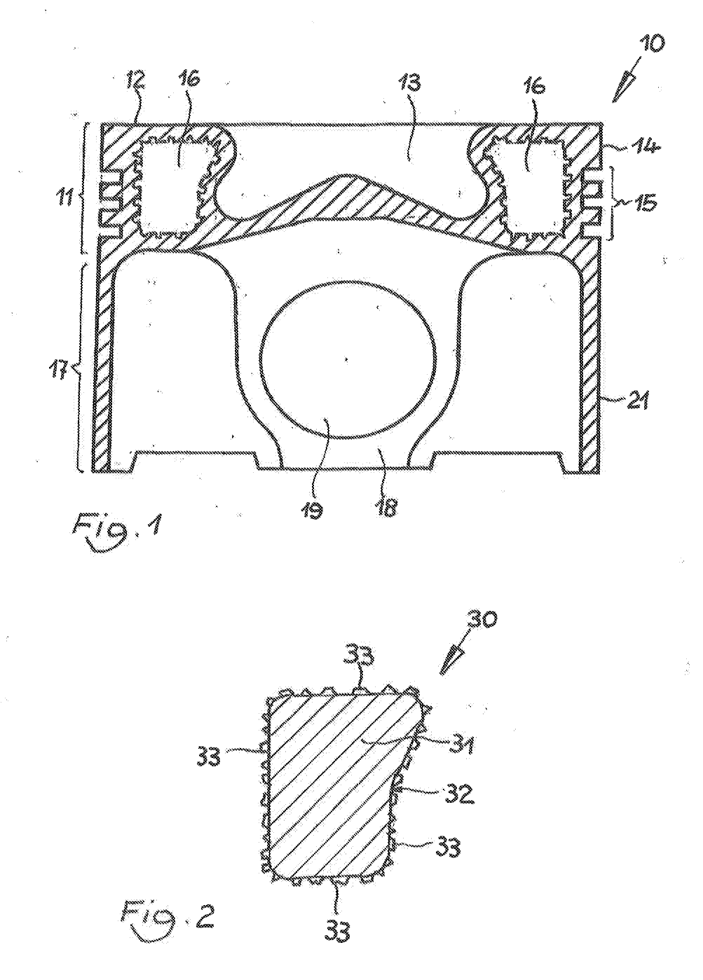

The method of the invention is suitable for any desired types and designs of cooling channel piston. FIG. 1, for example, shows a one-piece cast cooling channel piston 10. The cooling channel piston 10 has a piston head 11 with a piston crown 12, in which a combustion depression 13 is made. The piston head 11 also has a fire land 14 and also a ring section 15 with ring grooves for accommodating piston rings (not shown). At the level of the ring section 15, the piston is provided with an encircling cooling channel 16. The piston, furthermore, in a conventional way, has a piston shaft 17 with piston bosses 18, which are provided with boss bores 19 for accommodating a piston pin (not shown). The piston bosses 18 are joined to one another in a conventional way via running surfaces 21.

As indicated schematically in FIG. 1, the encircling cooling channel 16 has a surface having a surface roughness R_{z} of at least 200 μm, preferably of up to 400 μm, more preferably of up to 1 mm.

FIG. 2 shows a salt core 30 made of sodium chloride for use in the production of the inventive cooling channel piston 10 in accordance with FIG. 1. The salt core 30 has a salt core blank 31, whose surface 32 is covered with salt crystals 33 of sodium chloride.

In a first exemplary embodiment, the salt core 30 may be produced as follows:

The salt core blank 31 is first of all produced in a conventional way by cold pressing and sintering of a salt material such as sodium chloride. Care should be taken here to ensure that the pure salt material is used, i.e., a salt material which contains no extraneous substances or additives. After being sintered, the salt core blank 31 may be mechanically finished on its surface 32 in a known way to give a cross-sectional contour which is an extremely precise match for the cross-sectional contour of the cooling channel to be produced.

The completed salt core blank 31 is immersed into or sprayed with a saturated aqueous solution of the salt material, sodium chloride in the exemplary embodiment, so that its surface 32 is wetted by the solution. The salt core blank 31 is subsequently dried, in an oven, for example, at a temperature of just below 100° C., e.g. 95° C. to 98° C., until steam no longer emerges from the salt core blank. During the drying process, salt crystals 33 crystallize from the saturated solution and adhere to the surface 32 of the salt core blank 31.

After the end of the drying process, the resulting, completed salt core 30 is distinguished by a surface roughness R_{z} of at least 200 μm.

For the production of the cooling channel piston 10, the salt core 30 is placed in a conventional way into a corresponding casting mold and is cast with a metallic material, based for example on aluminum. After the conclusion of the casting process, the resulting piston blank has a cast-in salt core 30. The piston blank is finished in a known way, and the salt core 30 is rinsed out with water. The result is the cooling channel piston 10 as per FIG. 1.

In a modification of this method, the salt core blank 31, before being immersed into the saturated solution, is heated to a temperature of 80° C. to 100° C., in order to obtain particularly effective wetting of the surface 32 of the salt core blank 31 by the saturated solution.

In a second exemplary embodiment, the salt core 30 may be produced as follows:

First of all, as described above, a salt core blank 31 is produced. This blank is sprayed with a suitable solvent, preferably water, or with a solution of the salt material, preferably sodium chloride, or is immersed into the liquid in question. The surface of the salt core blank 31, which is still wet, is subsequently sprinkled with crystals of the salt material, sodium chloride in the exemplary embodiment, and is subsequently dried and used further as described. The grains used have a defined grain size distribution and/or a defined grain diameter distribution.

With this measure it is possible to set the surface roughness R_{z} of the salt core 30 with particular precision. For example, after using salt crystals with an average grain size of 500 μm, it was possible to measure a surface roughness R_{z} of 200 μm to 400 μm on the surface of the cooling channel 16 of the completed cooling channel piston 10. Salt crystals having an average grain diameter of 1 mm produced a surface roughness R_{z} of 700 μm to 900 μm on the surface of the cooling channel 16 of the completed cooling channel piston 10.

1. A method for producing a cooling channel piston, comprising:
producing a salt core blank by pressing and sintering a pure salt material having a surface roughness R_{z} of at most 60 μm;
one of:
immersing the salt core blank into a saturated solution of the salt material, or
spraying the salt core blank with the saturated solution of the salt material;
drying the salt core blank to form a salt core having a surface roughness R_{z} of at least 200 μm;
placing the salt core in a casting mold; and
casting a cooling channel piston from a metallic casting material.

2. A method for producing a cooling channel piston, comprising:
producing a salt core blank by pressing and sintering a pure salt material having a surface roughness R_{z} of at most 60 μm;
one of:
immersing the salt core blank into one of a solvent and a solution of the salt material, or
spraying the salt core blank with the one of a solvent and a solution of the salt material;
sprinkling the salt core blank with a salt material having at least one of a defined grain size distribution and a defined grain diameter distribution;
drying the salt core blank to form a salt core having a surface roughness R_{z} of at least 200 μm;
placing the salt core in a casting mold; and
casting a cooling channel piston from a metallic casting material.

3. The method as claimed in claim 1, wherein the salt material is sodium chloride.

4. The method as claimed in claim 1, wherein producing the salt core blank includes subjecting the soft core blank to mechanical finishing.

5. The method as claimed in claim 1, wherein the saturated solution includes at least one of solvent water and at least one polar organic solvent from a group including methanol, ethanol, isopropanol, diethyl ether, and acetone.

6. The method as claimed in claim 5, wherein the at least one polar organic solvent includes at least one crown ether.

7. The method as claimed in claim 1, wherein drying the salt core blank is done in agitated air.

8. The method as claimed in claim 1, wherein drying the salt core blank occurs at a temperature of at most 200° C.

9. The method as claimed in claim 7, wherein drying the salt core blank occurs at room temperature.

10. The method as claimed in claim 1, wherein the surface roughness R_{z} of the salt core is up to 1 mm.

11. The method as claimed in claim 1, further comprising heating the salt core blank to a temperature of 80° C. to 100° C. after producing the salt core blank.

12. The method as claimed in claim 1, further comprising heating the salt core to a temperature of 300° C. to 500° C. before placing the salt core in the casting mold.

13. The method as claimed in claim 1 wherein the casting material is aluminum-based.

14. A cooling channel piston produced by a process comprising:
producing a salt core blank by pressing and sintering a pure salt material having a surface roughness R_{z} of at most 60 μm;
one of:
immersing the salt core blank into one of a solvent and a solution of the salt material, or
spraying the salt core blank with the one of a solvent and a solution of the salt material;
drying the salt core blank to form a salt core having a surface roughness R_{z} of at least 200 μm;
placing the salt core in a casting mold; and
casting the cooling channel piston from a metallic casting material.

15. A cooling channel piston comprising a circulating cooling channel accommodated in a piston head, wherein a surface of the cooling channel has a surface roughness R_{z} of at least 200 μm.

16. The cooling channel piston as claimed in claim 15, the surface roughness R_{z} of the surface of the cooling channel is up to 1 mm.

17. The method as claimed in claim 2, wherein the salt material is sodium chloride.

18. The method as claimed in claim 2, wherein producing the salt core blank includes subjecting the soft core blank to mechanical finishing.

19. The method as claimed in claim 2, wherein the one of a solvent and a solution saturated solution includes at least one of solvent water and at least one polar organic solvent from a group including methanol, ethanol, isopropanol, diethyl ether, and acetone.

20. The method as claimed in claim 2, wherein drying the salt core blank is done in agitated air.
